(19) United States
(12) Patent Application Publication
(10) Pub. No.: US 2018/0101512 A1
(43) Pub. Date: Apr. 12, 2018

(54) Multi-Media Forms System

(71) Applicants: Dmitry Mikhailov, Vancouver (CA); Olga Sboychakova, Vancouver (CA)

(72) Inventors: Dmitry Mikhailov, Vancouver (CA); Olga Sboychakova, Vancouver (CA)

(73) Assignee: Flowfinity Wireless Inc., Vancouver (CA)

(21) Appl. No.: 15/721,084

(22) Filed: Sep. 29, 2017

Related U.S. Application Data
(60) Provisional application No. 62/405,544, filed on Oct. 7, 2016.

(51) Int. Cl. G06F 17/24; G06F 17/30; G06F 17/22; G06F 3/16; G10L 15/26

(52) U.S. Cl. CPC G06F 17/243; G06F 17/30914; G10L 15/265; G06F 17/2247; G06F 3/167; G06F 17/30241

(57) ABSTRACT

An inventory management or equipment inspection system that allows an audio or audio-video session to be recorded and converted to text, where the text is entered into semi-structured fields of a data form, while the audio track is being recorded. In other words, the system records an audio or audio-video session providing for concurrent collection of unstructured data stream, such as the audio track, and structured or semi-structured data, such as completion of text fields in the form. The system provides the ability to record the session, automatically convert the recorded voice to text, enter the text into data fields, and edit the text in the fields, while the audio or audio-video session is ongoing.

### REFERENCE TO RELATED APPLICATION

This application claims priority to U.S. Provisional Application Ser. No. 62/405,544 titled “Multi-Media Forms System” filed Oct. 7, 2016, which is incorporated by reference.

### TECHNICAL FIELD

The present invention relates to computer and mobile data collection systems and, more particularly, to a multi-media mobile data collection system suitable for inventory management and equipment inspection systems utilizing concurrent collection of unstructured data, such as an audio or audio-video track, together with semi-structured data, such as data entry into text fields in a form.

### BACKGROUND

In conventional data collection systems, the data collection service personnel (operator or user) typically collect data in one format at a time only. For example, the operator typically uses a paper form, an unstructured audio or video stream, or a structured form to capture the data at the place of collection into structured fields in an application form. In some cases, the operator may collect a copy or partial copy of the same data in alternative formats using separate hardware or software applications, such as a digital or tape recorder device along with a paper form. In cases when alternative formats of the data are captured, the different file formats are typically filed (stored) together for later retrieval and review. For example, this may be implemented by first saving data collected by a primary data collection method (e.g., audio or audio-video track) and then later appending the file to include a secondary data version (e.g., paper or semi-structured electronic form). This methodology is prone to delays in each portion being accessible, and potential human or computer errors when accessing or linking the data.

There is, therefore, a continuing need for improved multi-media data collection system suitable for inventory management and equipment inspection system.

### SUMMARY

The invention is directed to a forms system, such as an inventory management or equipment inspection system. The system allows an audio or audio-video session to be recorded and converted to text, where the text is entered into semi-structured fields of a data form, while the audio track is being recorded. In other words, the system records an audio or audio-video session providing for concurrent collection of unstructured data stream, such as the audio track, and structured or semi-structured data, such as completion of text fields in the form. The system provides the ability to record the session, automatically convert the recorded voice to text, enter the text into data fields, and edit the text in the fields, while the audio or audio-video session is ongoing.

Generally described, the invention includes recording a data streaming session, such as an audio or audio-video track. The data streaming session is converted to a number of text entries while the data streaming session is in progress; entering the text entries into semi-structured data fields of a form while the data streaming session is in progress. Edits to the text entries are received in the semi-structured data fields of the form while the data streaming session is in progress. The data streaming session is stored together with the data form containing the edit text entries converted from the data streaming session.

In one embodiment, text entries are manually entered (typed) into the semi-structured fields of the form by the operator. According to a second embodiment, machine voice-to-text conversion is used to automatically create the text entries in the semi-structured fields of the form. In both cases, the text entries are created while the data streaming session is recorded and stored along with the recording of the data streaming session.

It will be understood that additional techniques and structures for implementing particular embodiments of the invention and accomplishing the associated advantages will become apparent from the following detailed description of the embodiments and the appended drawings and claims.

### BRIEF DESCRIPTION OF THE FIGURES

FIG. 1 is a logic flow diagram illustrating an operating procedure for an Illustrative multi-media forms system.

FIG. 2 is an illustrative user interface display for a mobile device upon initial capture of a data streaming session in the multi-media forms system.

FIG. 3 is an illustrative user interface display for a mobile device in playback/edit model of a text entry converted from the recorded data streaming session in the multi-media forms system.

FIG. 4 is an illustrative user interface display for a mobile device in displaying a geo-map used to record a route traveled by a user when conducting a data collection session.

### DETAILED DESCRIPTION

A system and method for concurrent collection of structured or semi-structured data record and unstructured streaming (e.g., audio or audio-video) representation of the same data on a computer device (e.g., smartphone) is described. The intended purpose of this invention is to facilitate improvements in the collected structured data quality, by being able to review and compare the structured form of data collected to the other representation of the record (e.g., the streaming representation of the same data taken at the time of the original data collection). Another use case of the invention is to improve the speed of data collected in the field by using the unstructured data stream in lieu of the part of the structured data with the intended purpose to transcribe the structured data later and to be able to use the unstructured portion as a reference in addition to operator's recollection of the data values.

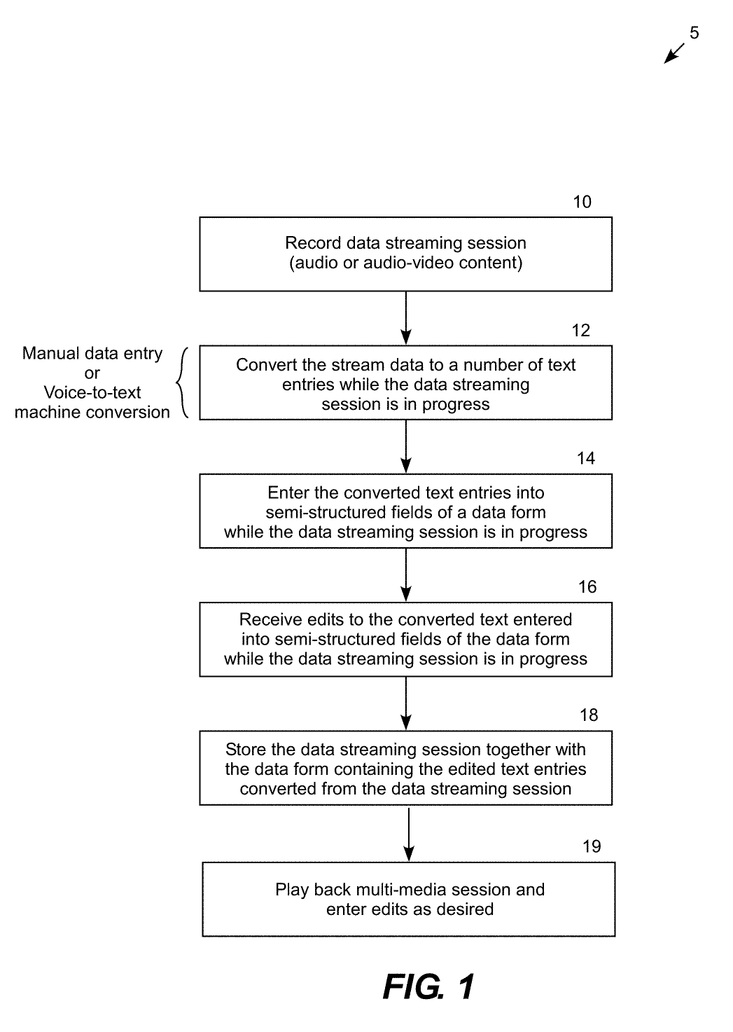

FIG. 1 is a logic flow diagram 5 illustrating an operating procedure for an Illustrative multi-media forms system. In step 10, the data collection system records a data stream session, such as audio or audio-video content. Step 12 is performed concurrently with step 10, in which all or a portion of the audio content is converted into text entries. Step 14 is performed concurrently with step 10, in which text received or parsed from the converted audio content is entered into one or more structured or semi-structured fields of a data collection form. This may include one or both of manual data entry or voice-to-text conversion. Step 16 is performed concurrently with step 10, in which the data collection system receives edits to the text data entered into the structured or semi-structured fields of the data collection form. Step 18 is performed concurrently with step 10, in which the data collection system stores the data streaming session together with the data form containing the edited text entries converted from the data streaming session. Step 19 follows step 18, in which the data collection system or any other suitable system plays back the multi-media session and edit are entered as desired as desired

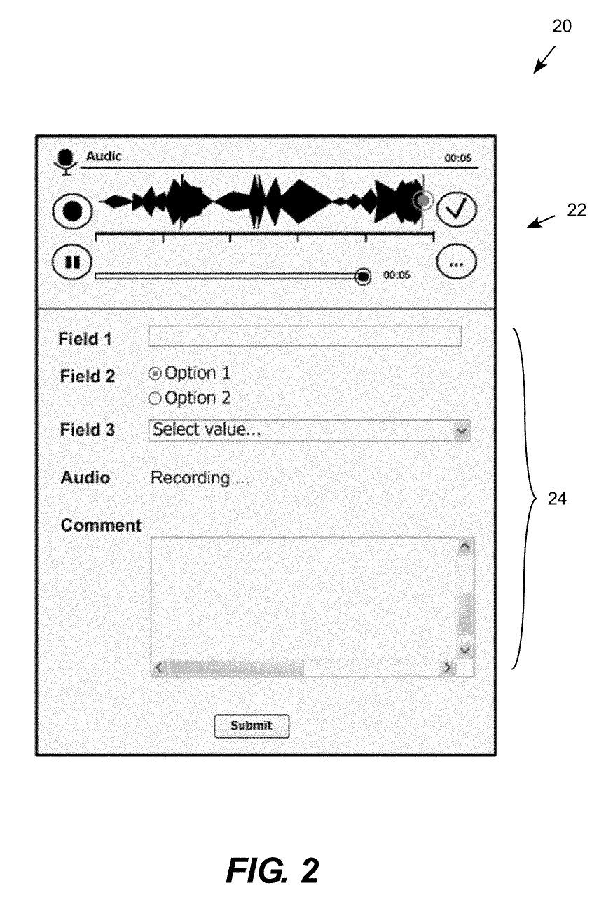

FIG. 2 is an illustrative user interface display 20 suitable for a smartphone application. The top portion of the display 20 includes a streaming data control panel 22 used to control the recording of an audio or audio-video session. The bottom portion of the display 20 includes a number of structured and semi-structured fields 24. Streaming audio data is automatically converted to text, parsed and entered into one or more of the structured and semi-structured fields 24 while the audio or audio-video session is in progress. The data collection operator (user) may enter data into the one or more of the structured and semi-structured fields 24, and desired, and edit the data automatically or manually entered into structured and semi-structured fields 24 while the audio or audio-video session is in progress. The user may also pause, rewind, fast-forward, skip and replay the streaming data content as desired.

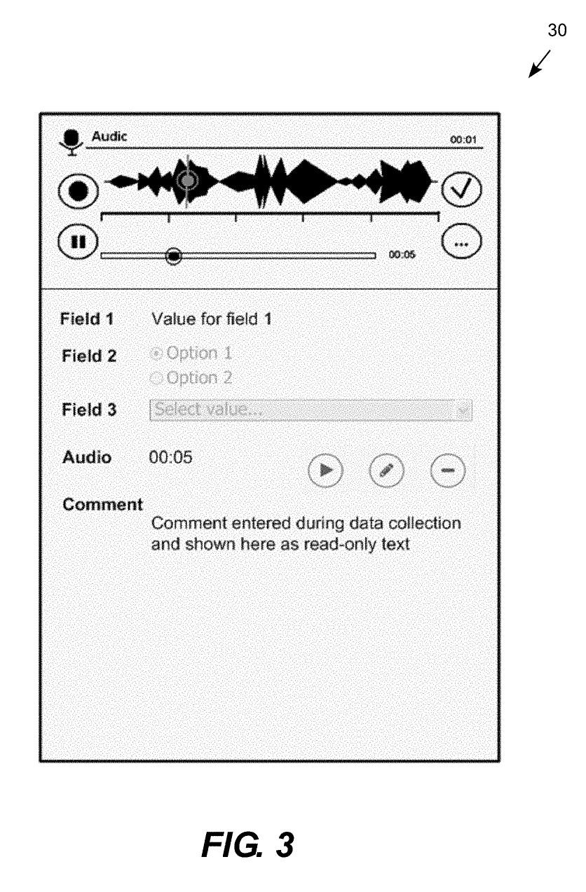

FIG. 3 is an illustrative user interface display 30 for a mobile device in playback/edit model of a text entry converted from the recorded data streaming session in the multi-media forms system. Again during a playback session, user may enter, edit and append data as desired. The user may also pause, rewind, fast-forward, skip and replay the streaming data content as desired.

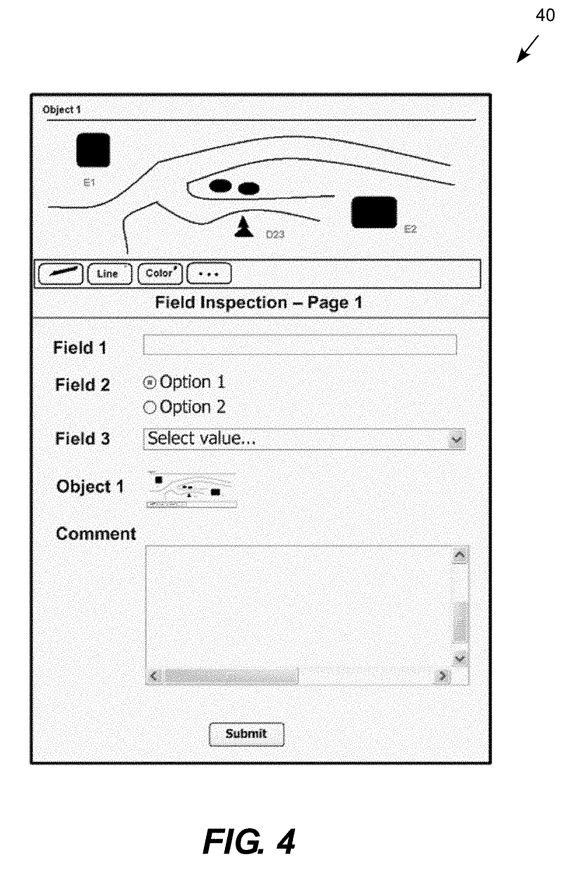

FIG. 4 is an illustrative user interface display 40 for a mobile device in displaying a geo-map used to record a route traveled by a user when conducting a data collection session. The data collection session includes the geo-map of the data collection site including coordinates of the structures to be inspected and displaying the current location of the user with ability to save a route traveled by the user. The data collection device may also display or announced navigation instructions to help navigate the user to or through the data collection subject, or to find the spots for the data collection in association with the displayed geo-map. As another option, the display 40 may show other graphical images, such as a schematic diagram, a diagram or illustration of a machine or mechanical part, or a picture of a person, place or feature. The data collection operator may also be able to modify the graphic images, for example to enter “as built,” “modifications” or “as found” updates to the graphic images. The display 40 may therefore use a graphical annotator tool as an editing method for the graphical data, with functions to draw, annotate and markup the graphical data, such as schematics and site layouts, as an alternative way of concurrently documenting the data collection session along with the collection of structured and semi-structured data. The user may also be able to receive files and research from remote sources, such as credentials, photos on file, bio-security data, repair instructions, Internet research, and so forth. The user may also take pictures, take measurements, and create other types of data as part of the data collection session. For example, the user may take measurements with a laser distance finder, thermometer, vibration detector, electric meter, chemical tester, or any other suitable measuring device. These and other types of data can be received, measured, created, edited, annotated, appended with metadata, and stored in connection with the data collection session. As a result, a wide range of multi-media data can become associated with the data collection session, time stamped, stored, and subsequently retrieved together in single data storage container or multiple internally referenced data storage containers.

The semi-structured portion of the data may include, but is not limited to, an electronic semi-structured form or a part of the form consisting of fields and lists of different logical data types, and may span one or more logical screens such as pages or tabs that can be navigated in either fixed or random order. The unstructured part of the data that is collected concurrently with structured portion may include but is not limited to the audio or audio-video stream recorded by the device, graphics or a set of graphics in various formats, location map, etc.

All structured and unstructured portions of the data are stored and are accessed alongside in the central data storage and together comprise the whole indivisible data unit (record). A user interface is provided for concurrent collection, access and manipulation of the multi-media data.

An embodiment of the present invention includes a method and system for providing an integrated approach to concurrently collecting structured and unstructured portions of a data collection process via a unique screen interface. Multiple data formats of the same data are concurrently collected, such as an audio or audio-video session and portions of that session converted to text, entered in semi-structured fields of a form, and edited as desired. These multiple data formats of the same data are treated as a single data storage unit that is saved into a storage system. The concurrent data collection process may be visualized to the operator by a split panel in which each panel is dedicated to a corresponding data format, where all panels are concurrently active and accessible to the operator.

One of the illustrative embodiments uses an audio or audio-video stream as an unstructured data source. Another embodiment uses the location map graphics as unstructured data source. The structured data part in both embodiments is represented by a data collection form. The specific format of the metadata of the form is defined by the form designer. In addition to the area or field that is reserved for the audio stream data, the for may include multiple structured and unstructured fields of different data types organized in multiple sections or lists, such as dropdowns, text boxes, grids, date, time fields, attachment field, etc.

It will be apparent to those skilled in data collection techniques that other media streams and formats may be used for the unstructured portion of the data, such as but not limited to video, graphics, digital documents, and the like. For example, the digital file may be a geo-map of the site including coordinates of the structures to be inspected and displaying the current location of the user with ability to save a route traveled by the user. As another example, the digital file could be a spreadsheet document supporting the inspection with ability for the user to annotate the items needing attention during the data collection quickly right during data entry process. The structured portion of the data record may be as simple as one field or as complex as multiple connected pages with different field types and multiple levels of data structure nesting. The unstructured information may contain multiple parts, and also that the structured information may have multiple parts. The user interface may facilitate concurrent access to more than two sections or parts of the record, which may include multiple structured parts or multiple unstructured parts or any combination of structured and unstructured parts as it is necessitated by the data collection use case. For example, as one of the illustrative embodiments of the model, the system may be configured to perform concurrent collection of two unstructured sections of the data in a multi-panel user interface.

The embodiment with audio or audio-video stream uses the mobile device equipped with a microphone and ability to run applications. The data collection device of this embodiment may include, but is not limited to, a stationary computer, tablet, mobile phone or any other computing device which is equipped with a display screen. The data collection device should also be capable of running applications, and have the ability to control audio recording activity via either embedded or externally connected audio source. The embodiment with graphical image uses the mobile device with ability to run application.

In the embodiment with audio or audio-video stream data source as an unstructured data source, the audio or audio-video stream may represent, but not limited to, an interview with a particular person, such as the location manager. Data translated from the interview session into text may be used to fill in the structured or semi-structured portion of a data collection form. The data collection operator may immediately view and edit the data translated into the data collection form concurrently with recording of the audio or audio-video session.

In the embodiment utilizing graphical data as an unstructured data source, the graphical data may represent by, but not limited to, a schematic diagram, a diagram or illustration of a machine or mechanical part, a location map, or a picture of a person, place or feature. The location images may be captured with a camera upon arrival at the location. Alternatively, the location images may be downloaded from a library of images, or otherwise prefilled into the data collection system prior to or upon entering the data collection location. The graphic images and displayed or announced navigation instructions may be used to help navigate the user to or through the data collection subject, or to find the spots for the data collection. The data collection operator is therefore to see the imaged of the data collection subject or location on screen of the data collection system for the duration of the data collection session. The data collection operator may also be able to modify the graphic images, for example to enter “as built,” “modifications” or “as found” updates to the graphic images. This embodiment may therefore use the graphical annotator tool as an editing method for the graphical data, with functions to draw, annotate and markup the graphical data, such as schematics and site layouts, as an alternative way of concurrently documenting the data collection session along with the collection of structured and semi-structured data.

When the data collection operator using a data collection device enters into the data collection mode for the record, and indicates the start of the media collection process, the operator may be presented with a split screen user interface. One panel of the split screen may be designated for graphic or streaming media, while the another portion of the split screen may be designated for a form with structured or semi-structured fields for capturing structured information. Data recorded on the graphic side may be parsed or marked for concurrent entry into the form side, where the operator may immediately edit the data entered into the form to ensure and verify accuracy of the information entered into the form. The indication of the start of the audio or graphical portion collection may be delayed from the actual opening of the form for editing and capture. Field-by-field data entry may be initiated by the operator, or it may be automatically initiated by the form logic based on automatically advancing data collection from a first form field to a second form field in accordance with predefined conditions associated with data entry or streaming data conditions. For example, data entry into a particular field may be automatically initiated when moving to the next field after a prior field has been indicated as completed, in accordance with a script for the data collection session, upon entering a particular page based on voice recognition, upon entering a particular page when a particular graphic page or audio file is initiated, and so forth. Split panels presented to the user are typically actionable at the same time with user easily being able to manipulate content in either of them in desired order. The designated audio panel allows recording the audio steam continuously and presenting the progress in an interactive way allowing the user to alter the process in real-time via either adjusting physical characteristics of the environment (e.g., moving the data collection device closer if the volume is displayed as low) or manually via on-screen commands (e.g., pausing and restarting the recording). Additional editing commands may be included, such as to cut a section of the recording, to enter a recording starting with a specific marker, change volume, etc. The designated graphical panel allows annotation using drawing tools or alteration of the graphical content by other techniques (e.g., by pasting image fragments, etc.). The designated structured panel may also allow the operator to switch between pages, select values for controls and enter text, and many other suitable operations.

More than two data collection panels may be used, such has a tri-screen, quad-screen, screen insets, or any number of panels or insets available for selection. Each panel may be available for selection, resizing and repositioning by user command. Once the data collection session is finished, the data collected from all panels (or a selected set of panels) is automatically associated with each other and saved into a consolidated record, which is saved into the storage database. For example, in one use case the operator may decide to stop the audio or graphical recording portion earlier prior to submission, while in another use case the recording may be automatically saved when the session is stopped, indicated as complete, or upon data entry into all fields of a specified data completion field. As another example, the record may have multiple structured or semi-structured fields, where each field is associated with a dedicated section of audio or audio-video data. Entering data into each form field and streaming data pair may be initiated by the operator or automatically based on certain pre-designed conditions. The media saved for such record may consist of multiple data objects or streams that each run concurrently with a specific section of the form data collected. In another variation of the form design, the structured part may contain additional fields that are to be filled without streaming media data present. In this case, the screen may switch to a single panel mode when appropriate, which may occur automatically, based on form logic, or in response to manual commands entered by the operator.

In an illustrative embodiment, a portrait style mobile screen panel is displayed above a structured data entry panel. It will be understood that screens with different dimensions may be used, and that the panel layouts may be adjusted as a matter of design choice, for example to side-by-side or other position as deemed suitable for facilitating best access to both panels' functionality. Due to size constraints of a mobile device in portrait mode, only two panels may be concurrently displayed as a design parameter. However, it will be understood that on large screens more than one concurrent panel may be shown, media capture panel(s) may be collapsed, resized, repositioned, displayed as insets, and many other suitable display options.

Data storage may be located locally on the same device and/or remotely in centralized or cloud data storage. If the saved record data is retrieved for review or editing by the operator at a later time, all structured and unstructured data becomes concurrently accessible for review. In editing mode, the layout and features may be mostly the same as in the initial capture model allowing for the audio unstructured part to append, edit or re-record all or parts of the audio stream using the split panel design. Graphical data may be modified, annotations may be entered or altered, and the original structured data can also be modified as selected by the operator. The review mode of the record which contains structured and unstructured data may be displayed in a split panel interface similarly to the capture mode. In review mode, all panels may be active allowing the user to interact with panels independently and concurrently. In review mode, the audio panel provides playback and audio stream feedback capabilities, such as but not limited to volume and frequency visuals. The structured data panel may be designed to present information in editable or non-editable format.

The operator may have the ability to remove the structured and unstructured parts individually and update the data storage with the resulting combination of structured or unstructured parts, and the operator may decide to delete the whole data collection record in which case all structured and unstructured parts currently associated into the record will be deleted from the data storage.

In one embodiment where multiple structure and/or unstructured parts are included into the record the system may be configured to show the status of data collection for each part to the user either in a dedicated screen area, panel or separate screen based on user request.

It will be appreciated that the invention may be used for a wide range of multi-media data and display types. The representative examples are provided as an illustrative embodiment without limiting the scope and applicability of the invention.

The present disclosure is particularly well suited to implementation on portable computing devices, which may communicate with a server system providing access to a number of client systems over a network, or as a dedicated computing system. As such, embodiments of the disclosure may comprise adapting or reconfiguring presently existing equipment. Alternatively, original equipment may be provided embodying the disclosure.

All of the methods described in this disclosure may include storing results of one or more steps of the method embodiments in a non-transient storage medium. The results may include any of the results described in this disclosure and may be stored in any manner known in the art. The storage medium may include any storage medium described in this disclosure or any other suitable storage medium known in the art. After the results have been stored, the results can be accessed in the storage medium and used by any of the method or system embodiments described in this disclosure, formatted for display to a user, used by another software module, method, or system, etc. Furthermore, the results may be stored permanently, semi-permanently, temporarily, or for some period of time. For example, the storage medium may be random access memory (RAM), and the results may not necessarily persist indefinitely in the storage medium.

Those having skill in the art will appreciate that there are various vehicles by which processes and/or systems and/or other technologies described in this disclosure can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described in this disclosure may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that various implementations may employ any suitable type of hardware, software, and/or firmware.

Those skilled in the art will recognize that it is common within the art to describe devices and/or processes in the fashion set forth in this disclosure, and then use engineering practices to integrate such described devices and/or processes into data processing systems. That is, at least a portion of the devices and/or processes described can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. All of the technology described in this disclosure is suitable for implementation using commercially available computing devices, such as network servers operated by the situational awareness system and smartphones or personal computers operated by members and customers. These computing devices may be interconnected via the Internet, mobile telephone voice and data system, or other data suitable network.

This disclosure sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components may be combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “functionally connected” to each other to achieve the desired functionality. Specific examples of functional connection include but are not limited to physical connections and/or physically interacting components and/or wirelessly communicating and/or wirelessly interacting components and/or logically interacting and/or logically interacting components.

While particular aspects of the present subject matter have been shown and described in detail, it will be apparent to those skilled in the art that, based upon the teachings of this disclosure, changes and modifications may be made without departing from the subject matter described in this disclosure and its broader aspects and, therefore, the appended claims are to encompass within their scope all such changes and modifications as are within the true spirit and scope of the subject matter described in this disclosure. Although particular embodiments of this disclosure have been illustrated, it is apparent that various modifications and embodiments of the disclosure may be made by those skilled in the art without departing from the scope and spirit of the disclosure. Accordingly, the scope of the disclosure should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. The disclosure is defined by the following claims, which should be construed to encompass one or more structures or function of one or more of the illustrative embodiments described above, equivalents and obvious variations.

The invention claimed is:

1. A method for recording multi-media data, comprising:
recording a data collection session including a data streaming session;
converting the data streaming session to a number of text entries while the data streaming session is in progress;
receiving the text entries into semi-structured data fields of a form while the data streaming session is in progress;
receiving edits to the text entries in the semi-structured data fields of the form while the data streaming session is in progress; and
storing the data streaming session together with the data form containing the edit text entries converted from the data streaming session.

2. The method of claim 1, further comprising receiving automatic voice-to-text entries and manual text entries into the semi-structured data fields of the form while the data streaming session is in progress.

3. The method of claim 1, further comprising displaying a location map and receiving data entries in association with the location map.

4. The method of claim 1, further comprising displaying a schematic diagram and receiving data entries in association with the schematic diagram.

5. The method of claim 1, further comprising displaying a diagram or illustration of a machine or mechanical part and receiving data entries in association with the a diagram or illustration of the machine or mechanical part.

6. The method of claim 1, further comprising displaying a picture of a person, place or feature and receiving data entries in association with the picture of the person, place or feature.

7. The method of claim 1, further comprising displaying a geo-map of a site of the data collection including indicia of structures to be inspected, an indication of a current location of location of a user, and displaying or recording a route traveled by the user during a data collection session.

8. The method of claim 1, further comprising displaying a control panel and receiving user inputs controlling the data streaming session via the control panel.

9. The method of claim 1, further comprising displaying a graphic image associated with a data collection session, and receiving and storing changes to the a graphic image during the data collection session.

10. The method of claim 1, further comprising displaying or announcing navigation instructions to guide a user through the data collection session.

11. The method of claim 1, further comprising displaying a split-screen user interface with data streaming controls in a first portion of the split-screen user interface, and a structured or semi-structured form in a second portion of the split-screen user interface.

12. The method of claim 1, further comprising automatically advancing data collection from a first form field to a second form field in accordance with predefined conditions associated with the streaming data.

13. The method of claim 1, further comprising playing back a stored data collection session and receiving edits to data entries of the session while playing back the stored data collection session.

14. A non-transient data storage medium storing computer executable instructions for causing a computer-controlled device to perform steps, comprising:
recording a data collection session including a data streaming session;
converting the data streaming session to a number of text entries while the data streaming session is in progress;
receiving the text entries into semi-structured data fields of a form while the data streaming session is in progress;
receiving edits to the text entries in the semi-structured data fields of the form while the data streaming session is in progress; and
storing the data streaming session together with the data form containing the edit text entries converted from the data streaming session.

15. The data storage medium of claim 14, further comprising receiving automatic voice-to-text entries and manual text entries into the semi-structured data fields of the form while the data streaming session is in progress.

16. The data storage medium of claim 14, further comprising displaying a location map and receiving data entries in association with the location map.

17. The data storage medium of claim 14, further comprising displaying a schematic diagram and receiving data entries in association with the schematic diagram.

18. The data storage medium of claim 14, further comprising displaying a diagram or illustration of a machine or mechanical part and receiving data entries in association with the a diagram or illustration of the machine or mechanical part.

19. The data storage medium of claim 14, further comprising displaying a picture of a person, place or feature and receiving data entries in association with the picture of the person, place or feature.

20. A handheld portable computing device operative for:
recording a data collection session including a data streaming session;
converting the data streaming session to a number of text entries while the data streaming session is in progress;
receiving the text entries into semi-structured data fields of a form while the data streaming session is in progress;
receiving edits to the text entries in the semi-structured data fields of the form while the data streaming session is in progress; and
storing the data streaming session together with the data form containing the edit text entries converted from the data streaming session.
